(19) United States
(12) Patent Application Publication
(10) Pub. No.: US 2004/0016083 A1
(43) Pub. Date: Jan. 29, 2004

(54) Carrying handle

(76) Inventor: Joy Cornett, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/205,654

(22) Filed: Jul. 24, 2002

(51) Int. Cl. E05B 1/00

(52) U.S. Cl. 16/422

(57) ABSTRACT

A protective cover for shopping bag handles comprises an elongated tube. The tube is curved along its length so that the bottom side thereof is concave and the top side thereof is convex. The tube has a slot running the entire length thereof adjacent the top side through which the flexible handles of a plastic or paper shopping bag are inserted.

### FIELD OF THE INVENTION

The present application relates to shopping bags, and more particularly to a protective handle for engaging the flexible handles of a shopping bag.

### BACKGROUND OF THE INVENTION

The ubiquitous paper and plastic shopping bags employed by almost all retail stores have a highly flexible handle. This handle conforms to the shape of the hand when being carried. When such bags are heavily loaded, the flexible handles constrict and concentrate the forces in a narrow band across the carrying person's hand, causing discomfort and sometimes pain. Thus, if the carrier must traverse any distance, he or she must set the bag down, rest, and then resume the journey due not to the weight of the bag and its contents, but due to the concentrated force on the fingers caused by the flexible

### SUMMARY OF THE INVENTION

The present invention therefore provides a protective cover for engaging and encapsulating the flexible handles of paper and plastic shopping bags with the purpose of distributing the weight of the shopping bag or bags over a broader area of a carrier's hand. The protective cover preferably comprises an elongated tube that is curved along its length so that the bottom side is concave and the top side is convex. The tube has a slot running the entire length thereof adjacent the topside through which the flexible handles of a plastic or paper shopping bag or bags may be inserted. It is preferred that the tube be composed of a semi-rigid material, and it is also preferred that the slot be centered in the top portion of the tube.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of the protective handle of the present invention shown with the handle of a plastic shopping bag inserted therein; and

FIG. 2 is a lateral cross-section of the handle shown in FIG. 1.

### DETAILED DESCRIPTION OF THE PREFERRED EMBODIMENT

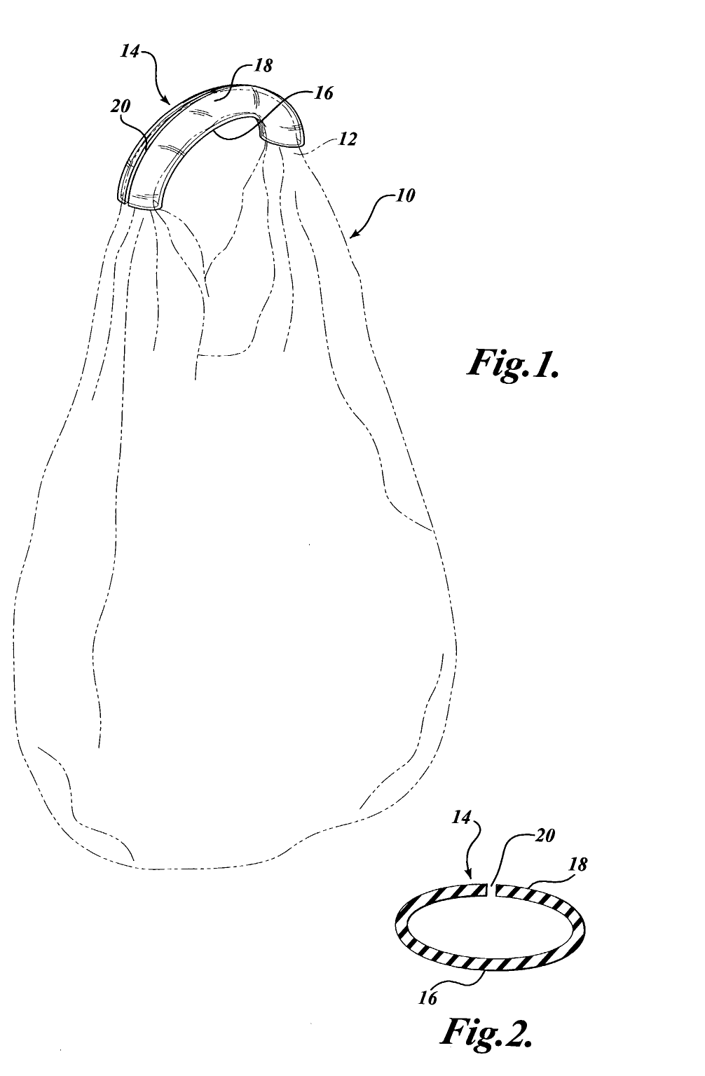

Reffering to FIG. 1, a shopping bag 10 has an integral handle 12 formed therein. A plastic bag is shown in the drawing; however, it is understood that a bag composed of paper or other conventional material having a handle, either integral or affixed thereto, may be effectively used with the protective cover handle 14 constructed in accordance with the present invention. Protective handle 14 is preferably composed of a semi-rigid yet slightly flexible material such as vinyl tubing. Vinyl tubing usable with the present invention is available in hardware and home improvement stores, is semi-rigid and yet flexible enough to serve the purpose of the present invention. Other materials may be utilized, including materials that are substantially rigid.

Referring to both FIG. 1 and FIG. 2, the carrying handle 14 is curved along its longitudinal axis such that its under side 16 is concavely curved, while its upper side 18 is convexly curved. As shown in FIG. 2, the tube 14 preferably has a flattened shape in the lateral cross-section such that the edges of the tube are separated further from each other than are the top and the bottom of the tube. A slot 20 is formed adjacent the upper surface 18 of the tube 14. The slot 20 runs the entire length of the tube and is preferably positioned in the central-most portion of the upper surface 18.

In use, the tube is positioned beneath the handles and the handles slid through the slot 20. As mentioned above, it is preferred that the handle be semi-rigid, but be sufficiently flexible so that the slot 20 can be opened slightly to receive varying widths of handles on shopping bags 10.

Once the handle or handles are inserted, the user grasps the under side 16 of the protective handle 14 and lifts upwardly. Because the material is semi-rigid, the downward forces on the handle caused by the loading in the bag 10 are distributed more or less evenly across the inner bottom surface 16 of the tube. Thus, the forces are distributed over the entire bottom portion of the tubing, reducing significantly the surface area loading normally applied by a conventional shopping bag handle that has not been encased in a protective handle in accordance with the present invention.

While the preferred embodiment of the invention has been illustrated and described, it will be appreciated that various changes can be made therein without departing from the spirit and scope of the invention.

embodiments of the invention in which an exclusive property or privilege is claimed are defined as follows:

1. A protective cover for shopping bag handles comprising:
an elongated tube, said tube being curved along its length so that the bottom side is concave and the top side is convex, said tube having a slot running the entire length thereof adjacent the top side thereof for receiving a flexible handle of a shopping bag.

2. The protective cover of claim 1, wherein said tube comprises semi-rigid material.

3. The protective cover of claim 1, wherein the slot is centered in the top, central portion of said tube.

4. The protective cover of claim 1, wherein the tube is comprised of vinyl tubing.

5. A method for protecting the hand of a person carrying a shopping bag having flexible handles, comprising:
inserting the flexible handles in an elongated tube, the tube being curved along its length so that the bottom thereof is concave and the top thereof is convex, the tube having a slot running the entire length thereof through which the flexible handles are inserted; and
lifting the bag by lifting upwardly on the bottom of the tube.

6. The method of claim 5, wherein the tube is semi-rigid.

7. The method of claim 6, wherein the tube is comprised of vinyl tubing.

8. The method of claim 5, wherein the slot is centered in the central top portion of the tubing.

9. The method of claim 5, wherein the tubing has a flattened cross-section.
